(19) United States
(12) Patent Application Publication
(10) Pub. No.: US 2020/0021077 A1
(43) Pub. Date: Jan. 16, 2020

(54) SHORT-PULSE LASER SYSTEM

(71) Applicants: FRAUNHOFER-GESELLSCHAFT ZUR FÖRDERUNG DER ANGEWANDTEN FORSCHUNG E.V., München (DE); HÜBNER GMBH & CO. KG, Kassel (DE)

(72) Inventors: Daniel MOLTER, Kaiserslautern (DE); Michael KOLANO, Grünstadt (DE)

(73) Assignees: Fraunhofer-Gesellschaft zur Förderung der angewandten Forschung e.V., München (DE); Hübner GmbH & Co. KG, Kassel (DE)

(21) Appl. No.: 16/335,728

(22) PCT Filed: Sep. 21, 2017
(86) PCT No.: PCT/EP2017/073890

§ 371 Date: Mar. 22, 2019

(30) Foreign Application Priority Data
Sep. 28, 2016 (DE) 10 2016 118 391.1

(51) Int. Cl. H01S 3/067; H01S 3/105; H01S 3/11

(52) U.S. Cl. CPC H01S 3/06712; H01S 3/06729; H01S 3/06791; H01S 3/1118; H01S 3/1053

(57) ABSTRACT

A short-pulse laser system includes a first and a second resonator, and an amplification means for amplifying the electromagnetic pulses both in the first and in the second resonator. The first resonator supports precisely one first linear polarization state, and the second resonator supports precisely one second linear polarization state perpendicular to the first polarization state. The short-pulse laser system has first and second birefringent material sections. The first birefringent material section and/or the second birefringent material section is designed in such a way that a difference between the sum of the optical path length of the first resonator in the first birefringent material section and the optical path length of the first resonator in the second birefringent material section and the sum of the optical path length of the second resonator in the first birefringent material section and the optical path length of the second resonator in the second birefringent material section can be changed in an adjustable manner.

The present invention relates to a short-pulse laser system for generating electromagnetic pulses with a first resonator, which has a first beam path, a second resonator, which has a second beam path, and an amplification means, wherein the amplification means is arranged both in the first beam path, so that it amplifies electromagnetic pulses in the first resonator during operation of the short-pulse laser system, and in the second beam path, so that it amplifies electromagnetic pulses in the second resonator during operation of the short-pulse laser system, wherein the first beam path and the second beam path are spatially superimposed at least in sections in the amplification means and wherein the first resonator is set up in such a way that it supports precisely one first linear polarization state of the electromagnetic pulses, and the second resonator is set up in such a way that it supports precisely one second linear polarization state, wherein the first and the second polarization states are perpendicular to each other.

The generation of short and ultrashort electromagnetic pulses is gaining ever more importance in science and technology. Short electromagnetic pulses can be used, for example, for materials processing, wherein use is made of the fact that the entire energy of a pulse is distributed only over a very short time interval, typically around 100 fs, with the result that very high powers per pulse can be achieved.

However, short-pulse laser systems have also become particularly important in the field of spectroscopy, where short electromagnetic pulses are used to implement time-resolved pump/probe experiments. Here, in principle, use is made of the fact that a physical system, for example a semiconductor material, is excited with a first pulse and the effect of the pump pulse is probed with the aid of a second pulse, which is then typically short compared with the response of the physical system.

An example of such a pump/probe experiment is the measurement of charge-carrier dynamics in a semiconductor material. The material is excited with a first pulse, i.e. charge carriers which alter the reflectivity or transmittance of the material are generated in the material. If a second short electromagnetic pulse now strikes the material, it is reflected more strongly or less strongly depending on the number of charge carriers present in the material. If the time delay between the pump pulse and the probe pulse can be adjusted, the charge-carrier dynamic in the semiconductor material can be measured in a time-resolved manner.

In addition, short-pulse laser systems are used in terahertz (THz) time-domain spectroscopy. Here, an emitter emitting THz radiation is excited with a first pulse, while a detector gated with a second short pulse probes or detects the electromagnetic wave generated by the emitter in a time-resolved manner. It is particularly noteworthy that in fact the electrical field strength of the THz radiation emitted by the emitter can be detected in a time-resolved manner in this way. THz time-domain spectroscopy can also be understood as a pump/probe experiment.

A prerequisite for carrying out both pump/probe experiments and THz time-domain spectroscopy is that short optical pulses are available, of which in each case a first is used for exciting and a second pulse, which can have a time delay relative to the first pulse, is available for probing.

In the state of the art such pump/probe experiments are implemented, for example, in that a short-pulse laser system emits a short electromagnetic pulse which is then split into a pump pulse and a probe pulse by means of a beam splitter, wherein the probe pulse is shifted in time relative to the pump pulse over an adjustable delay distance.

Such a delay distance is often implemented by a linear translation stage with mirrors attached to it, which represents a length-variable optical path. In order to be able to provide higher probe rates, the delay distance is additionally often implemented with the aid of a mechanically oscillating system for rapid movement of the mirror back and forth. However, such oscillating systems also reach their (mechanical) limits towards higher probe rates.

In order to be able to implement even higher probe rates, a short-pulse laser system is known from DE 10 2012 113 029 A1, which relates to a short-pulse laser with two resonators spatially separated in sections, wherein the polarizations of the electromagnetic radiation in the two resonators are orthogonal to each other. The resonator length of one resonator is adjustable around the resonator length of the other resonator. As the repetition rate or the time gap between two successive pulses generated by a short-pulse laser is directly proportional to the resonator length, in this way the time offset between the generating and the detecting electromagnetic pulses can be adjusted.

However, it has been shown that such a short-pulse laser system is very sensitive to mechanical and thermal influences. The mechanical and thermal properties of the laser system have to be compensated for in a complex manner. In addition, the need for sectional spatial separation of the two beam paths of the first and of the second resonator leads to power losses at the required beam splitter.

In contrast, the object of the present invention is to provide a short-pulse laser system for generating optical pulses which is thermally and mechanically stable. Another object of the present invention is to provide a short-pulse laser system with increased starting power.

At least one of the previously named objects is achieved by a short-pulse laser system for generating electromagnetic pulses with a first resonator, which has a first beam path, a second resonator, which has a second beam path, and an amplification means, wherein the amplification means is arranged both in the first beam path, so that it amplifies electromagnetic pulses in the first resonator during operation of the short-pulse laser system, and in the second beam path, so that it amplifies electromagnetic pulses in the second resonator during operation of the short-pulse laser system, wherein the first beam path and the second beam path are spatially superimposed at least in sections in the amplification means, wherein the first resonator is set up in such a way that it supports precisely one first linear polarization state of the electromagnetic pulses, and the second resonator is set up in such a way that it supports precisely one second linear polarization state of the electromagnetic pulses, wherein the first and the second polarization states are perpendicular to each other, wherein the short-pulse laser system has a first birefringent material section and a second birefringent material section, wherein the first beam path and the second beam path run collinearly in the first birefringent material section and in the second birefringent material section, wherein the first birefringent material section and the second birefringent material section are designed and set up in such a way that in one state of the first birefringent material section and of the second birefringent material section the sum of the optical path length of the first beam path in the first birefringent material section and the optical path length of the first beam path in the second birefringent material section is equal to the sum of the optical path length of the second beam path in the first birefringent material section and the optical path length of the second beam path in the second birefringent material section, and wherein the first birefringent material section and/or the second birefringent material section is designed in such a way that a difference between the sum of the optical path length of the first beam path in the first birefringent material section and the optical path length of the first beam path in the second birefringent material section and the sum of the optical path length of the second beam path in the first birefringent material section and the optical path length of the second beam path in the second birefringent material section can be changed in an adjustable manner.

The aim of such a short-pulse laser system is to implement electromagnetic pulses, of which a first pulse train can be used to excite a physical system and a second pulse train can be used to probe a physical system. The system makes it possible to rapidly alter a time offset between the first pulse and the second pulse that is stable vis-à-vis mechanical and thermal influences. The system additionally functions with as few components as possible.

The basic idea of the short-pulse laser system according to the invention is to use the same volume of amplification means simultaneously in two resonators to generate electromagnetic pulses, with the result that two resonators function with only one amplification means. In addition, the first and the second beam paths run collinearly at least in the birefringent material sections responsible for the time offset between the two pulse trains. In this way, the essential components of the two resonators are subject to the same thermal and mechanical influences, with the result that in particular length alterations due to these influences occur in both resonators and have no influence on the time offset between the two pulse trains.

In an embodiment, however, the first and the second beam paths run completely collinearly to each other over the entire length of the first and of the second resonator. In particular, in such an embodiment the first and the second beam paths of the first and, respectively, second resonators are subject to the same mechanical and thermal influences.

In order that, at the same time, the two resonators are as independent of each other as possible, and that the pulses in particular do not influence each other in the amplification means, the two resonators are designed such that they support linear polarization states perpendicular to each other. In an embodiment, such polarization states perpendicular to each other have an at least reduced mode competition in the amplification means.

Electromagnetic pulses within the meaning of the present application can be pulses from the entire electromagnetic spectrum, but preferably from the visible or infrared spectral range. In particular electromagnetic pulses with a wavelength around 1310 nm or around 1550 nm, i.e. in the telecommunications windows, in which optical components for fibre lasers are commercially available, have proved their worth.

When, within the meaning of the present invention, reference is made to a short-pulse laser system or short electromagnetic pulses, this means in particular pulses with a duration of less than 500 fs, preferably of less than 200 fs and particularly preferably of less than 100 fs.

In addition, the short-pulse laser system itself is equipped such that the optical resonator lengths of the two resonators can be changed relative to each other, with the result that a time offset between the pulses emitted by the two resonators can be adjusted.

According to the present invention the relative alteration of the path length of the first beam path of the first resonator and of the second beam path of the second resonator is based on an alteration of the difference between the optical path lengths.

For this purpose, the short-pulse laser system has a first and a second birefringent material section, which are designed and set up in such a way that they have a state in which the sum of the optical path length of the first beam path in the first birefringent material section and the optical path length of the first beam path in the second birefringent material section is equal to the sum of the optical path length of the second beam path in the first birefringent material section and the optical path length of the second beam path in the second birefringent material section.

Provided that the two resonators outside the two birefringent material sections likewise have identical optical path lengths for the electromagnetic radiation with the respective polarization, in this state of the resonator, which could also be called the zero state, the optical path lengths of the first beam path and of the second beam path are identical. Both resonators then have the same repetition or repeating rate of the electromagnetic pulses generated in them.

It is understood that the first and the second birefringent material sections are also designed and set up in such a way that, in addition to the state in which the sum of the optical path length of the first beam path in the first birefringent material section and the optical path length of the first beam path in the second birefringent material section is equal to the sum of the optical path length of the second beam path in the first birefringent material section and the optical path length of the second beam path in the second birefringent material section, they also have or can be brought into such states in which this is precisely not the case.

By altering the difference in the optical path lengths between the two resonators, the difference between the repetition rates of the pulses in the two resonators is varied. During the alteration of the difference between the optical path lengths in the resonators, the relative phasing of the pulses from the first resonator also shifts relative to the pulses from the second resonator. This variation of the phasing due to the alteration of the difference between the optical path lengths of the two resonators is observable on a sample as a variation of the time offset between the pulses arriving there.

In an embodiment of the invention the first and/or the second birefringent material sections are designed and set up precisely such that when the difference between the optical resonator lengths is varied the zero state is traversed. In other words, in this embodiment the first and/or the second birefringent material sections are designed such that when the difference in the optical path lengths is varied the first resonator initially has a smaller optical path length than the second resonator, then both resonators have the same optical length and thereafter the first resonator has a greater optical length than the second resonator.

In an embodiment of the invention the first birefringent material section and the second birefringent material section, which each have a fast axis and a slow axis, are rotated relative to each other in such a way that the fast axis of the first birefringent material section forms an angle of 90° with the fast axis of the second birefringent material section, i.e. the fast axes are perpendicular to each other.

In an embodiment of the invention the first polarization state is parallel to the fast axis of the first or of the second birefringent material section.

In an embodiment, if the geometric length of the first birefringent material section and/or of the second birefringent material section is altered compared with the previously described zero state, the two beam paths with polarizations perpendicular to each other have a difference in their optical path lengths due to the birefringent property of these material sections.

In an embodiment, the first birefringent material section and/or the second birefringent material section in the resonators is therefore designed in such a way that its geometric length can be changed in an adjustable manner.

If there is an alteration of the difference between the optical path lengths due to an alteration of the geometric length of a medium with birefringence, the alteration of the optical path length difference is “reduced” compared with the geometric path length alteration, i.e. the sensitivity is lowered. The stretching is then effected, unlike in the case of a path length alteration in only one of the beam paths, as is known from the state of the art, no longer on a nanometre scale, but on a micrometre scale.

In an embodiment the first and/or the second birefringent material sections are designed such that when the difference in the geometric lengths is varied the first material section initially has a smaller geometric length than the second material section, then both material sections have the same geometric length and thereafter the first material section has a greater geometric length than the second material section.

In an embodiment, for example, this can be implemented by choosing the first material section such that initially, i.e. when unextended, it has a shorter geometric length than the second material section, wherein the first material section is extendable such that it can be brought to the same geometric length as the second material section by stretching and can be stretched beyond this to a geometric length which is greater than the geometric length of the second material section.

In an alternative embodiment the geometric lengths of both birefringent material sections can be changed in an adjustable manner. In an embodiment the geometric lengths of both material sections are extendable, wherein in the initial state, i.e. without extension of one of the two material sections, both material sections have the same geometric length and are in the zero state.

In an embodiment of the invention the short-pulse laser system has a device for altering the geometric length of the first and/or of the second birefringent material section. Such a device can be, for example, a tempering device, which cools or heats the first and/or the second birefringent material section in order to bring about a thermal length alteration.

In an alternative embodiment the device for altering the geometric length of the first and/or of the second birefringent material section is a mechanical device which exerts a compressive or tensile force on the material section, with the result that the latter alters its geometric length.

In a further embodiment of the invention the short-pulse laser system has a device for altering the difference between the optical path length of the first beam path and the optical path length of the second beam path, which functions without an alteration of the geometric path length of the first and/or of the second beam path. For this purpose, this device acts directly on the refractive indices of the first and/or of the second birefringent material section and alters the difference between the refractive index of the fast axis and the refractive index of the slow axis. Such an alteration of the difference between the refractive indices of a birefringent material section can be effected, for example, by squeezing the birefringent material section, in particular of a birefringent fibre, in a direction deviating from the propagation direction or by bending the birefringent material section.

In an embodiment of the invention the first birefringent material section and the second birefringent material section are polarization-maintaining optical waveguides.

By optical waveguides within the meaning of the present application is meant in particular fibre optical waveguides, preferably made of glass. These are called optical fibres for short in the following.

One possibility for changing the length of the polarization-maintaining optical waveguide of the first birefringent material section and/or of the second birefringent material section is, for example, a mechanical device which stretches the polarization-maintaining optical waveguide. Such apparatuses typically have a device on which several turns of the polarization-maintaining optical waveguide are wound, wherein the device makes it possible to automatically extend the turns in one or more directions.

Polarization-maintaining optical waveguides are implemented as polarization-maintaining optical fibres in one embodiment. Polarization-maintaining optical fibres are optical fibres in which the polarization of linearly polarized light is preserved during the propagation of the electromagnetic wave through the fibre. There is thus no loss of optical power into the other polarization modes. Such fibres are also called birefringent fibres.

The operating principle of polarization-maintaining optical fibres is typically based on the fact that the core of the polarization-maintaining fibre in cross section does not have isotropic properties, but rather a marked stress axis. If electromagnetic radiation with a linear polarization parallel to this stress axis or also perpendicular to this stress axis is coupled into the fibre, this electromagnetic radiation retains its linear polarization state during the propagation in the fibre.

Such non-isotropic cores can in particular be implemented in that the cladding of the fibre is constructed non-rotationally symmetrical in a targeted manner and thus tensile or compressive stresses are exerted on the core which lead to an isotropy of the core in cross section. Examples of polarization-maintaining optical fibres are so-called PANDA fibres, Bow-Tie fibres and elliptical clad fibres.

In such a polarization-maintaining fibre the two modes of the first and second resonators of the short-pulse laser system linearly polarized perpendicular to each other can propagate independently of each other.

When, within the meaning of the present application, reference is made to a first and a second resonator, this comprises in particular embodiments in which these two resonators have beam paths which are completely collinear to each other, i.e. are not to be spatially separated from each other. However, the two resonators differ by the polarization of the electromagnetic radiation that they support. As the linear polarization states in the two resonators are perpendicular to each other, the two resonators are independent of each other in the sense that there is no crosstalk between these two channels defined by the polarization. Therefore, a completely collinear arrangement then also has two resonators within the meaning of the present application.

In an embodiment of the invention an active or a passive mode coupler is provided in the first and second beam paths of the first and second resonators. An example of a passive mode coupler is a saturable absorber. Such a saturable absorber is suitable in particular for a linear fibre laser, wherein the saturable absorber forms part of the highly reflective mirror.

In an embodiment the short-pulse laser system is a fibre laser. The amplification means is formed by the optical fibre itself in a fibre laser.

For one thing, such a fibre laser has the advantage that its components are commercially available because they are widespread in the field of optical telecommunications technology. For another thing, however, the two polarization states of the two resonators orthogonal to each other can be easily guided in optical fibres with which such a fibre laser is implemented without crosstalk occurring between the two channels formed by the polarization states orthogonal to each other.

In an embodiment of the invention a fibre amplifier lying in the first and in the second beam path is provided behind an output of the first and/or second resonator of the short-pulse laser system in the beam direction, wherein an output of the fibre laser is preferably connected to the fibre amplifier. In this way at least the electromagnetic pulses generated in one of the resonators of the short-pulse laser system can be boosted, and thus their power can be raised to a level which makes it possible to carry out experiments effectively or to operate a THz spectrometer.

It is possible here that the pulses of the first resonator and of the second resonator also propagate spatially overlapping or collinearly in the fibre amplifier and, because of their orthogonal polarization states, are boosted independently of each other. However, embodiments in which only the pulses from one of the resonators are boosted are also conceivable. For example, it can be expedient for a THz time-domain spectrometer if pulses which were generated in the first resonator and which are directed onto a generator for electromagnetic radiation in the THz frequency range are boosted, while pulses which were generated in the second resonator and are directed onto a detector for electromagnetic radiation in the THz frequency range are not boosted.

In an embodiment of the invention a polarization beam splitter is provided behind the short-pulse laser system or behind the fibre amplifier, with the result that two spatially separated beam paths are provided. At this point, i.e. behind the output of the short-pulse laser system or behind the output of the fibre amplifier, a polarization beam splitter serves to spatially separate from each other the two polarization states perpendicular to each other, the first and second beam paths of the first and second resonators collinear within the short-pulse laser system or within the amplifier, with the result that one pulse can be used to excite and the other pulse can be used to probe a physical system.

In addition, at least one of the above-named objects is also achieved by an optical pump/probe arrangement with a short-pulse laser system such as has been described previously.

In an embodiment of the invention the optical pump/probe arrangement is set up such that pulses which were generated in the first resonator are directed onto a physical system to excite it and pulses which were generated in the second resonator are directed onto the physical system to probe it.

In an embodiment of the invention such an optical pump/probe arrangement is a THz time-domain spectrometer which is set up such that pulses which were generated in the first resonator are directed onto a generator for electromagnetic radiation in the THz frequency range and pulses which were generated in the second resonator are directed onto a detector for electromagnetic radiation in the THz frequency range.

Such generators and detectors for electromagnetic radiation in the THz frequency range, which are either operated or gated with optical pulses, are in particular non-linear optical crystals and so-called photoconductive or photoconducting switches based on semiconductor components.

Further advantages, features and possible applications of the present invention are made clear with reference to the following description of embodiments of it and the associated figures.

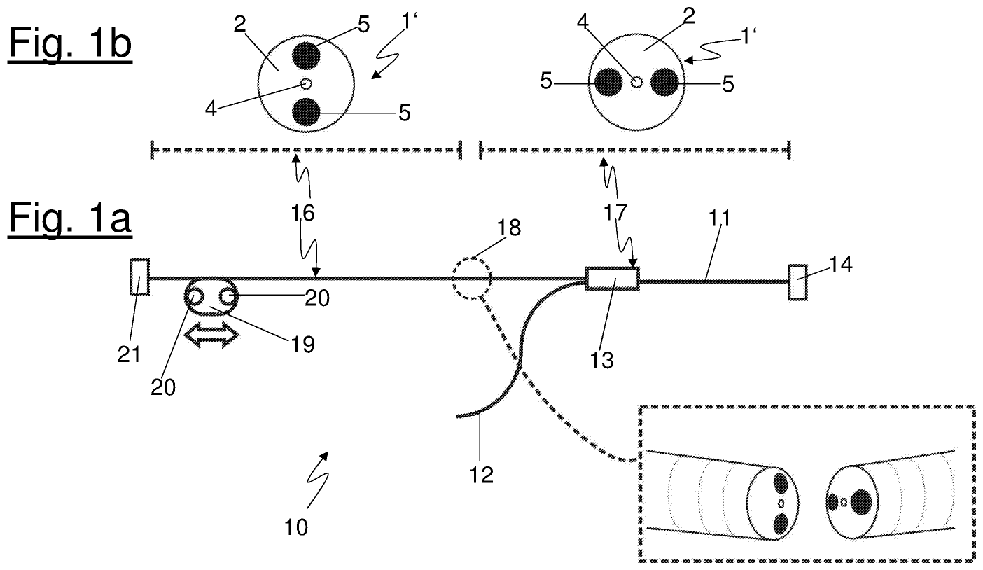

FIGS. 1a and 1b show schematic representations of a first embodiment of a short-pulse laser system according to the present invention with linear resonators.

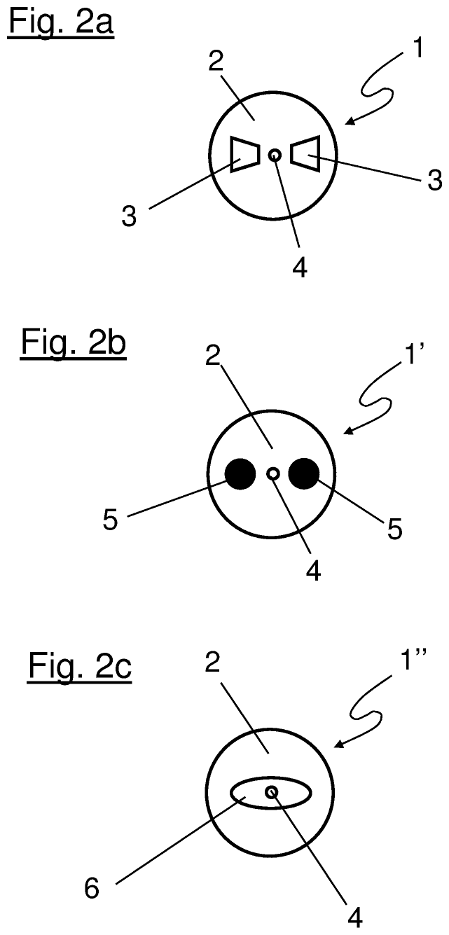

FIGS. 2a to 2c show embodiments of polarization-maintaining optical fibres.

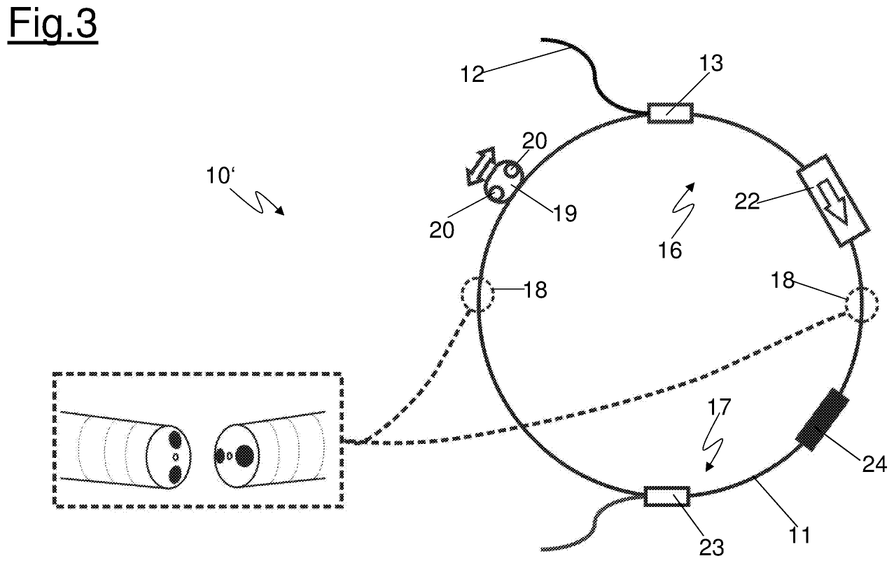

FIG. 3 shows a schematic representation of a second embodiment of a short-pulse laser system according to the present invention with ring resonators.

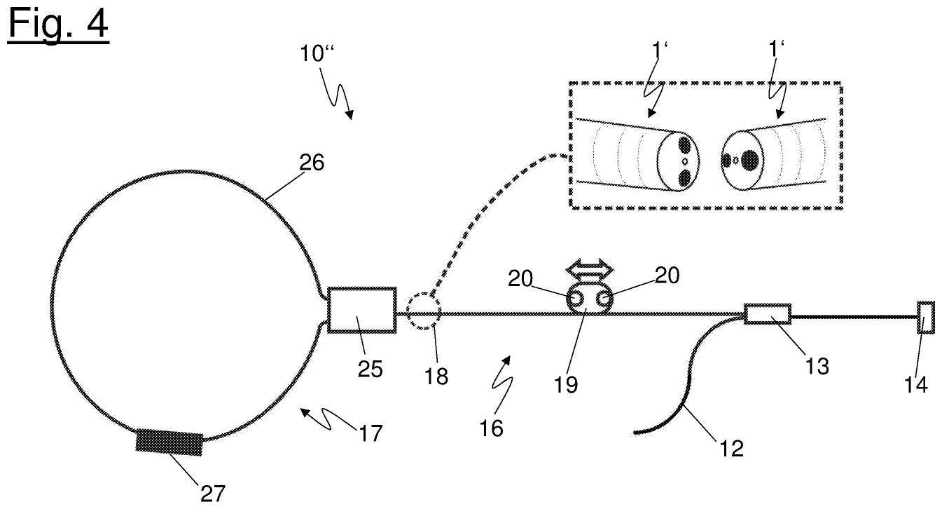

FIG. 4 shows a schematic representation of a further embodiment of a short-pulse laser system according to the present invention with ring resonators.

In the figures identical elements are given identical reference numbers.

The short-pulse laser systems shown in FIGS. 1, 3 and 4 are fibre lasers based on optical fibres which are designed for operation at a wavelength of 1.55 μm.

The optical fibres used are so-called polarization-maintaining fibres 1, 1′, 1″ with a core 4, to which stresses are applied in a targeted manner in one direction by a special design of the cladding of the fibres. In this way, electromagnetic radiation which is coupled into these fibres with a linear polarization parallel or perpendicular to the marking direction propagates without noteworthy proportions of the radiation being transferred from one polarization state into the other during the propagation through the fibre. In other words, in such polarization-maintaining fibres there is no crosstalk between the two channels formed by the linear polarization states perpendicular to each other.

FIGS. 2a to 2c show examples of such polarization-maintaining fibres 1, 1′, 1″, such as can be alternatively used to construct the fibre laser system from FIGS. 1, 3 and 4. FIG. 2a shows a so-called Bow-Tie fibre 1, in which two structures 3 which together with the core 4 resemble a bow-tie in the sectional view are introduced into the fibre cladding 2. The two structures 3 in the cladding 2 of the fibre 1 result in the core 4, which is embedded in the centre of the cladding 2, having a marked axis, into which for example linearly polarized electromagnetic radiation can be coupled in a polarization-maintaining manner.

FIG. 2b shows an alternative embodiment of such a polarization-maintaining optical fibre 1′, which is called a PANDA fibre. In order to build up a corresponding stress in the core 4, two glass strands 5, which have approximately the same effect as the bow-tie structures 3 of the fibre 1 from FIG. 2a, are run in the cladding 2 of the optical fibre 1′.

FIG. 2c shows a third embodiment of a polarization-maintaining optical fibre 1″, in which within the cladding 2 the core 4 is embedded in an elliptical structure 6, which impresses the necessary anisotropic stress on the core 4. Such a polarization-maintaining optical fibre 1″ is also called an elliptical clad fibre.

Due to the formation of all fibre components of the short-pulse laser systems 10, 10′, 10″ from FIGS. 1, 3 and 4 as polarization-maintaining fibres 1, the short-pulse laser systems 10, 10′, 10″ have two completely collinear channels or resonators, which support two linear polarizations perpendicular to each other. Although they are completely collinear, these two resonators are separated from each other in such a way that they experience as little mutual influencing as possible and no crosstalk. This means that both channels form resonators that are largely independent of each other in a single system. In particular, there is an at least reduced mode competition between the two channels in the amplification means 11.

The amplification means is formed by an erbium-doped fibre section 11. The latter is excited with the aid of an optical pump 12 in order to be able to provide the necessary amplification of the radiation oscillating in the lasers 10, 10′, 10″. The pump radiation 12 is coupled into the amplifying fibre section 11 with the aid of a wavelength-division multiplexing fibre coupler 13.

While both polarization modes of the first and of the second resonator in the same fibre of the laser 10, 10′, 10″ propagate collinearly within the fibre laser 10, 10′, 10″, the two polarization channels behind the output coupler 14, 23 can be spatially separated from each other with the aid of a polarization beam splitter (not shown in the figures).

As the electromagnetic radiation both in the linear fibre laser 10 from FIGS. 1a and 1b and in the ring resonators of the fibre lasers 10′, 10″ from FIGS. 3 and 4 is completely collinear, in all embodiments shown the geometric path lengths of the first and second beam paths of the first and second resonators are exactly the same length. In order nevertheless to be able to introduce an optical wavelength difference, all three lasers 10, 10′, 10″ have two birefringent fibre sections 16, 17.

In all embodiments these two fibre sections are given the reference numbers 16 and 17, wherein here reference is made first to the embodiment according to FIGS. 1a and 1b, as in particular the schematic representation from FIG. 1b makes it easier to understand the basic idea of the present invention. Both polarization-maintaining fibre sections 16, 17 are realized by PANDA fibres as birefringent material sections within the meaning of the present application. However, the fibre sections at the splices 18 connecting them are rotated relative to each other by 90° about their longitudinal axes, as is represented schematically in FIG. 1b and in the inserts of FIGS. 1a, 3 and 4.

While a linear polarization in the fibre section 16 initially propagates along the fast axis of the fibre 1′, it propagates along the slow axis of the fibre section 17 rotated relative thereto by 90°. If the geometric length in one fibre section 16 is now altered, this results in the same alteration of the geometric length for both channels, but in a difference between the optical path lengths due to the birefringent property of the fibre 1′. However, as the optical path length is decisive for the repetition rate of the pulses in the resonators, a stretching of the fibre section 16 relative to the fibre section 17 results in an alteration of the difference between the optical path lengths and thus in an alteration of the repetition rates of the pulses in the two resonators.

In order to achieve a stretching of the fibre section 16, this fibre section has a fibre stretcher 19. This fibre stretcher 19 consists of two support posts 20, the spacing of which can be adjusted and varied with the aid of a piezo element. Several fibre loops of the fibre section 16 are laid around the two support posts 20, with the result that a movement of the two support posts 20 away from each other results in a noteworthy length alteration of the fibre section 16 and thus in an alteration of the difference between the repetition rates of the two resonators.

Here the fibre sections 16, 17 have exactly the same geometric length in one state and thus the two linear polarization states of the electromagnetic radiation in the two resonators or channels also have the same optical path lengths in this state. In the embodiment shown the state of exactly the same geometric length is specifically chosen such that an extending of the fibre section 16 with the aid of the fibre stretcher 19 is necessary to achieve it. During a stretching of the fibre section 16 with the fibre stretcher 19, the fibre section 16 is therefore extended from a state in which the fibre section 16 has a shorter geometric length than the fibre section 17 such that it has the same geometric length as the fibre section 17, and beyond this such that it has a greater geometric length than the fibre section 17. In other words, the repetition rate of the first resonator is initially greater than that of the second resonator, and in the course of the stretching of the fibre section 16 the repetition rates of the two resonators equal each other, before the repetition rate of the first resonator becomes smaller than the repetition rate of the second resonator.

This variation of the repetition rates results in a shifting of the phasings of the pulses from the two resonators and thus in a variation of the time offset between the pulses from the first resonator and the pulses from the second resonator.

In the linear design of the resonators of FIGS. 1a and 1b a small proportion of the power of the laser pulses oscillating in the resonators is coupled out of the fibre laser 10 by means of the output mirror 14. The majority of the power remains in the resonators and is reflected back by the end mirror 21.

Here the end mirror 21 also acts as a mode coupler, as it is designed as a saturable absorber. The saturable absorber 21 acts as a passive optical switching element and thus serves for passive Q-switching of the two laser resonators. The saturable absorber consists of a material with an intensity-dependent absorption coefficient. In the embodiment represented the saturable absorber 21 is a semiconductor component, namely a SESAM (Semiconductor Saturable Absorber Mirror), which acts both as a saturable absorber and as an end mirror. The saturable absorber results in a boundary condition of the resonators, which in turn has the effect that the laser generates modes phase-coupled to each other.

The ring laser 10′ from FIG. 3 is also constructed from two polarization-maintaining fibre sections 16, 17, wherein these are connected to each other at two splices 18. Again, the fast axes of the two fibre sections 16, 17 at the splices 18 are rotated relative to each other by 90°, with the result that an alteration of the geometric path length in one fibre section 16 with the aid of the fibre stretcher 19 results in an optical path length difference between the two collinear resonators. The ring laser 10′ additionally has an optical diode 22 in the beam paths of the two collinear resonators, in order to prevent the formation of standing waves in the resonators. The coupling out of the ring laser is effected via a fused fibre coupler 23, which couples part of the power out of the ring resonators. A saturable absorber 24 likewise serves as a mode coupler in the ring laser 10′.

The laser 10″ from FIG. 4, on the other hand, combines a linear resonator structure with a ring structure. Again, two polarization-maintaining fibre sections 16, 17 are connected to each other with their fast axes rotated relative to each other by 90° at a splice 18. The fibre section 17 is connected to the linear part of the laser 10″ with the aid of a 2×1 fused fibre coupler 25. In order to achieve the complete return of the power propagating in the ring 24 back into the linear part of the laser system 10″, a non-reciprocal element 27 is provided in the ring 26.

For the purpose of original disclosure, it is pointed out that all features, as revealed to a person skilled in the art from the present description, the drawings and the claims, even if they have been described specifically only in connection with particular further features, can be combined both individually and in any combinations with others of the features or groups of features disclosed here, unless this has been explicitly ruled out or technical circumstances make such combinations impossible or meaningless. The comprehensive, explicit representation of all conceivable combinations of features is dispensed with here merely for the sake of the brevity and readability of the description.

While the invention has been represented and described in detail in the drawings and the above description, this representation and description is done merely by way of example and is not intended to limit the scope of protection as defined by the claims. The invention is not limited to the embodiments disclosed.

Modifications of the disclosed embodiments are obvious for a person skilled in the art from the drawings, the description and the attached claims. In the claims the word “to have” does not rule out other elements or steps, and the indefinite article “a” or “an” does not rule out a plurality. The mere fact that particular features are claimed in different claims does not rule out the combination thereof. Reference numbers in the claims are not intended to limit the scope of protection.

### LIST OF REFERENCE NUMBERS

1, 1′, 1″ polarization-maintaining fibres
2 cladding
3 structures
4 core
5 glass strands
6 elliptical structure
10, 10′, 10″ short-pulse laser system
11 amplification means
12 fibre section guiding pump radiation
13 wavelength-division multiplexing fibre coupler
14, 23 output coupler
16, 17 fibre sections
18 splice
19 fibre stretcher
20 support posts
21 end mirror
22 diode
24 saturable absorber
25 2×1 fused coupler
26 ring
27 non-reciprocal element

1. A short-pulse laser system for generating electromagnetic pulses, comprising
a first resonator, which has a first beam path,
a second resonator, which has a second beam path, and
an amplification means,
wherein the amplification means is arranged both in the first beam path, so that it amplifies electromagnetic pulses in the first resonator during operation of the short-pulse laser system, and in the second beam path, so that it amplifies electromagnetic pulses in the second resonator during operation of the short-pulse laser system,
wherein the first beam path and the second beam path are spatially superimposed at least in sections in the amplification means and
wherein the first resonator is set up in such a way that it supports precisely one first linear polarization state of the electromagnetic pulses and the second resonator is set up in such a way that it supports precisely one second linear polarization state of the electromagnetic pulses, wherein the first and the second polarization states are perpendicular to each other,
wherein
the short-pulse laser system has a first birefringent material section and a second birefringent material section, wherein the first beam path and the second beam path run collinearly in the first birefringent material section and in the second birefringent material section,
wherein the first birefringent material section and the second birefringent material section are designed and set up in such a way that in one state of the first birefringent material section and of the second birefringent material section the sum of the optical path length of the first beam path in the first birefringent material section and the optical path length of the first beam path in the second birefringent material section is equal to the sum of the optical path length of the second beam path in the first birefringent material section and the optical path length of the second beam path in the second birefringent material section, and
wherein the first birefringent material section or the second birefringent material section is designed in such a way that a difference between the sum of the optical path length of the first beam path in the first birefringent material section and the optical path length of the first beam path in the second birefringent material section and the sum of the optical path length of the second beam path in the first birefringent material section and the optical path length of the second beam path in the second birefringent material section can be changed in an adjustable manner.

2. The short-pulse laser system according to claim 1, wherein the first beam path and the second beam path are collinear over the entire length of the first and of the second resonator.

3. The short-pulse laser system according to claim 1, wherein the first birefringent material section and the second birefringent material section each have a fast axis and a slow axis, wherein the fast axis of the first birefringent material section is rotated by 90° relative to the fast axis of the second birefringent material section.

4. The short-pulse laser system according to claim 3, wherein the first polarization state is parallel to the fast axis of the first or of the second birefringent material section.

5. The short-pulse laser system according to claim 1, wherein the short-pulse laser system has a device for altering the geometric length of the first and/or of the second birefringent material section and/or a device for altering a difference between a first refractive index and a second refractive index of the first and/or of the second birefringent material section.

6. The short-pulse laser system according to claim 1, wherein the first birefringent material section and the second birefringent material section are polarization-maintaining optical fibres.

7. The short-pulse laser system according to claim 6, wherein the short-pulse laser system has a device for mechanically stretching or compressing the first birefringent material section or the second birefringent material section.

8. The short-pulse laser system according to claim 1, wherein the short-pulse laser system is a fibre laser.

9. The short-pulse laser system according to claim 8, wherein the short-pulse laser system has a mode coupler.

10. An optical pump/probe arrangement comprising a short-pulse laser system according to claim 1.

11. The optical pump/probe arrangement according to claim 10, wherein the optical pump/probe arrangement is set up such that pulses which were generated in the first resonator are directed onto a physical system to excite it, and pulses which were generated in the second resonator are directed onto the physical system to probe it.

12. The optical pump/probe arrangement according to claim 10, wherein the optical pump/probe arrangement is set up such that pulses which were generated in the first resonator are directed onto a generator for electromagnetic radiation in the THz frequency range, and pulses which were generated in the second resonator are directed onto a detector for electromagnetic radiation in the THz frequency range.
